(19) United States
(12) Patent Application Publication
(10) Pub. No.: US 2008/0311282 A1
(43) Pub. Date: Dec. 18, 2008

(54) Method and Device for Stabilizing a Toothbrush for One-Handed Use

(76) Inventor: Keith Hammon, Pompano Beach, FL (US)

Correspondence Address: MAYBACK & HOFFMAN, P.A., 5722 S. FLAMINGO ROAD #232, FORT LAUDERDALE, FL, 33330, US

(21) Appl. No.: 11/764,582

(22) Filed: Jun. 18, 2007

(51) Int. Cl. B05D 3/12; A46B 15/00; A46B 5/00

(52) U.S. Cl. 427/2.29; 15/143.1

(57) ABSTRACT

A toothbrush has a handle with first and second opposing sides, a distal end, and a proximal end opposing the distal end, the proximal end having bristles on the first side. A suction-cup stabilizer is located on the second side of the handle substantially centered between the proximal end and the distal end and, when pressed against a countertop surface, prevents the toothbrush from moving laterally along the surface when toothpaste is being applied to the toothbrush bristles.

### FIELD OF THE INVENTION

The present invention relates generally to toothbrushes, and more particularly relates to a stable toothbrush that can readily accept the application of toothpaste without being held or being stabilized by a user while application occurs.

### BACKGROUND OF THE INVENTION

As many people have discovered, simple daily activities, such as preparing meals, getting dressed, brushing one's teeth, and others, are made surprisingly difficult when one arm or hand is injured. This is because our arms and hands usually work in coordination with each other to accomplish tasks. When one of these coordinating arms is no longer available, the remaining appendage is left to do all of the work.

As most people are aware, brushing of one's teeth is important because food, drinks, or other substances left on a person's teeth for an extended period of time can result in deleterious effects. Examples of these effects are gum disease, halitosis, and tooth decay, among others. Gum diseases include periodontitis, or pyorrhea, which is a disease involving inflammation of the gingiva. Often persisting unnoticed for many years in a patient, such conditions can result in loss of clinical periodontal attachment between the teeth and the surrounding alveolar bone. Tooth decay is an infectious disease that damages the structures of teeth. These diseases can lead to pain, tooth loss, infection, and, in severe cases, death.

While brushing with only one hand or arm is the universal method of brushing, applying toothpaste to the toothbrush with only one arm is not. First, a typical toothbrush is made mostly of plastic and, therefore, is lightweight and easy to move, slide, or cause to rollover. Second, because toothpaste is very thick and, of course, pasty, when the toothpaste needs to be transferred from the tube to the bristly head of the toothbrush, a certain amount of force is needed to separate the toothpaste from the tube. If the lightweight toothbrush is sitting on a countertop, which can also be slippery, the toothbrush will have a tendency to slide along the countertop rather than stay put and provide the force necessary to separate the paste from the tube and leave it on the bristles. This problem makes what is a simple task for a two-armed person, a very difficult one for a single-armed person.

U.S. Pat. No. 6,349,445 discloses a toothbrush with a suction cup on a backside of the toothbrush. The suction cup is provided for the purpose of hanging the toothbrush from a wall for storage and for drying. Because the suction cup is located only at the end opposite the bristle head, and due to the fact that it is made of a very flexible material, the head portion easily twists and is displaced, rotating around the suction cup when the toothpaste is attempted to be placed on the bristles. This displacement does not make it any easier to place toothpaste on the toothbrush head.

U.S. Pat. No. 6,076,223 also discloses a toothbrush with a suction cup on the very end of the toothbrush with the suction cup axis being orthogonal to the toothbrush axis. In such a configuration, the brush can be placed on a countertop on its end. In this upright position, toothpaste cannot be applied to the bristles because gravity will simply cause it to fall off.

Therefore a need exists to overcome the problems with the prior art as discussed above.

### SUMMARY OF THE INVENTION

Briefly, in accordance with the present invention, disclosed is a toothbrush with a handle that has first and second opposing sides, a distal end, and a proximal end opposing the distal end, with bristles on the first side of the proximal end. The toothbrush also includes a stabilizer located on the second side of the handle substantially centered between the proximal end and the distal end.

In accordance with a feature of the present invention, the stabilizer is a suction device, such as a suction cup.

In accordance with a further feature of the present invention, the stabilizer is a crossbar with friction-inducing material on a bottom surface of the crossbar.

In accordance with another feature of the present invention, the stabilizer is integrated into the handle.

In accordance with a yet another feature of the present invention, stabilizer is removably attached to the handle.

In accordance with yet a further feature of the present invention, the stabilizer is a fin located on the distal end of the toothbrush.

In accordance with yet another feature, an embodiment of the present invention includes a method for applying a substance to bristles on a toothbrush, where the method includes placing a toothbrush onto a substantially horizontal surface, applying force to a center portion of the toothbrush in a direction toward the horizontal surface sufficient to deform a suction device attached to the toothbrush, removing the force, and applying a substance to bristles on the toothbrush without tipping the toothbrush.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a side elevation view of a toothbrush with a toothbrush stabilizer in accordance with an embodiment of the present invention.

FIG. 2 is a perspective view of the toothbrush of FIG. 1 with the stabilizer of FIG. 1 adhered to a surface in accordance with an embodiment of the present invention.

FIG. 3 is a perspective view of the toothbrush of FIG. 1 with a removable stabilizer in accordance with an embodiment of the present invention.

FIG. 4 a top plan view of the toothbrush of FIG. 1 with a crossbar and a fin stabilizer in accordance with another embodiment of the present invention.

FIG. 5 a process flow diagram of a toothbrush stabilization process in accordance with an embodiment of the present invention.

FIG. 6 a process flow diagram of a toothbrush stabilization process in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to an embodiment, overcomes problems with the prior art by providing a stabilizer for a toothbrush that allows the toothbrush to be temporarily removably coupled to a surface.

Described now are exemplary embodiments of the present invention.

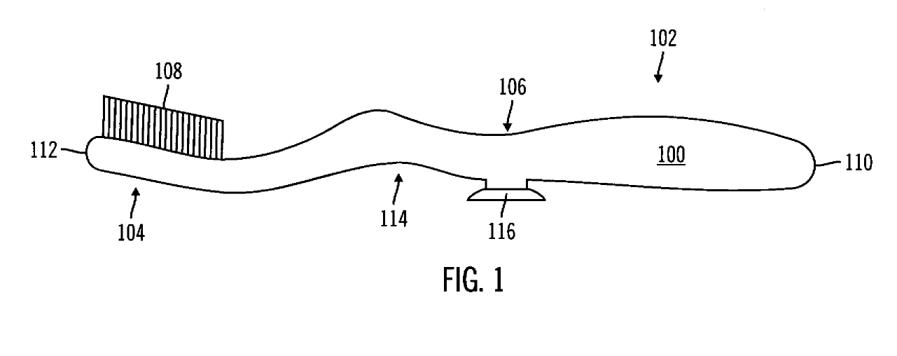

With reference now to the figures, FIG. 1 depicts a toothbrush 100 that includes a handle portion 102. The handle portion has a distal end 1 10 and an opposing proximal end 112. At the proximal end 112 is a head portion 104. The handle portion 102 and head portion 104 are generally one continuous piece of material and share a first side 106 having a plurality of bristles 108. The bristles 108 are available in a variety of materials and are used to clean material off of and out from between a user's teeth. The bristles 108 are also able to hold and apply toothpaste, which is beneficial for proper cleaning of the tooth surfaces.

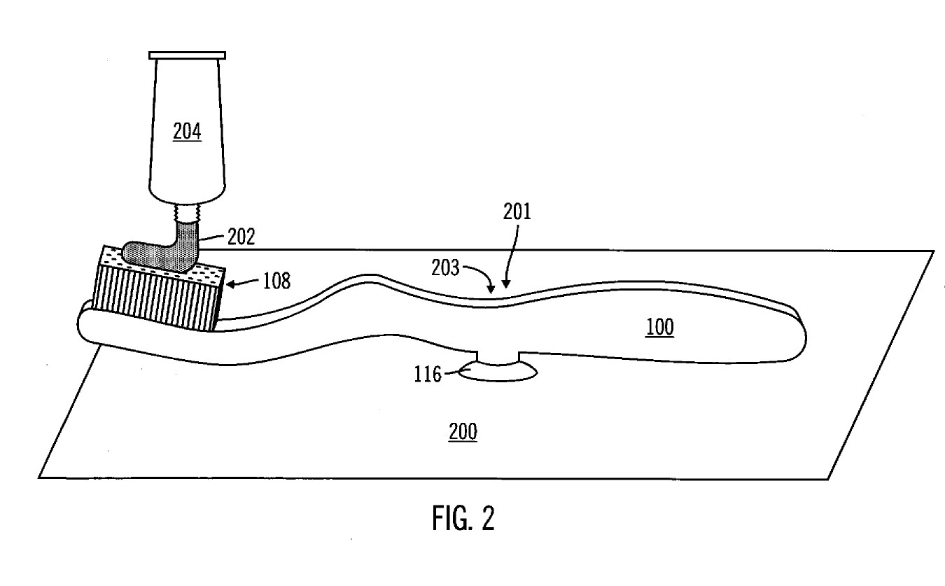

Opposite the upper first side 106 is a lower second side 114. The second side 114 is provided with a stabilizer 116, which, in the embodiment shown, is a suction device. The suction device 116 allows, as is shown in FIG. 2, the toothbrush 100 to be secured to a horizontal surface 200 and stabilized, at least temporarily. The toothbrush 100 with stabilizer 116 is secured to a surface 200 by applying force 201 to a center portion 203 of the toothbrush 100 in a direction toward the horizontal surface 200 sufficient to deform the suction device 116 attached to the toothbrush 100. The deformation forces air out from between the suction device 116 and the surface 200 and creates a vacuum there between, which remains when the force 201 is removed.

The suction device 116 thereby secures the toothbrush 100 to the surface 200 so that toothpaste 202 can be transferred to the bristles 108 from a tube 204 of toothpaste without the need for further holding or securing of the toothbrush 100. In one embodiment of the present invention, the suction device 116 is substantially centered between the distal 110 end and the proximal end 112. “Substantially centered,” as used herein, can mean any point along the handle 102 that is within about 35% of a total length of the toothbrush, either way from a point halfway between an extent, i.e. tip, of the distal end 110 and an extent of the proximal end 112. In other words, the suction device will not be placed within 15% of the total length from either end. By substantially centering the stabilizer 116, the stabilizer 116 is not in the way of the user's hand and does not make contact with the user's mouth when the user is performing the brushing. Of course, the closer the stabilizer 116 is to the head portion 104, the more stability is increased. Thus, it is envisioned moving the stabilizer 116 as close to the head portion 104 as desired without impacting the ability of the user to keep the stabilizer 116 out of the user's mouth.

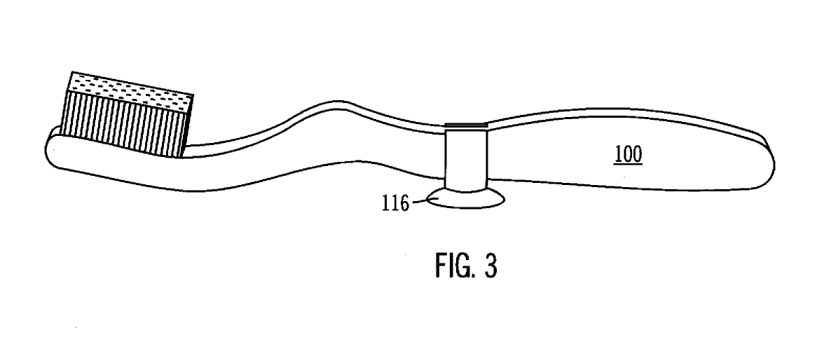

FIG. 3 shows another embodiment of the present invention, where, instead of the stabilizer 116 being integral with the handle 102 of the toothbrush 100, as shown in FIGS. 1 and 2, the stabilizer 116 clips onto or slides onto the handle 102 so that the stabilizer 116 becomes removably attached to the handle 102. The removable embodiment of the stabilizer 116 is not limited to a clip, but can screw on, insert into, or attach to the handle 102 of the toothbrush 100 in any other way. The removable stabilizer 116 is advantageous in that it can be left attached to the sink or other surface 200 and the toothbrush 100 removed during brushing. This ensures that the user's hand is not bothered by the stabilizer during use. Further, in such a configuration, the stabilizer 116 can be attached anywhere along the extent of the toothbrush bristle 100, even next to or at the bristles 108.

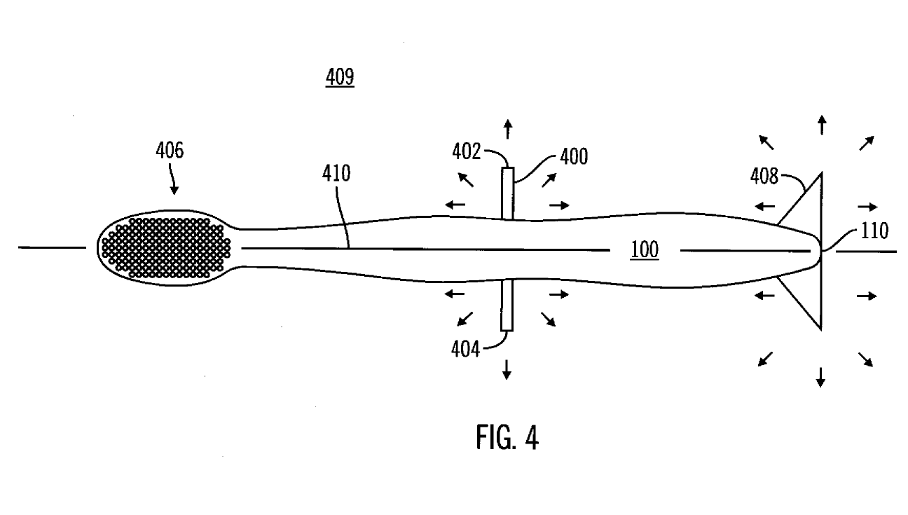

FIG. 4 shows a top view of another embodiment of the present invention where a different kind of stabilizer is used. In this embodiment, the stabilizer 400 is crossbar. The crossbar 400 has two legs 402 and 404 that extend perpendicular to the handle 100 and provide stability against handle roll-over. Crossbar 400 ensures that the bristles 406 do not make contact with the countertop 408. As with the suction stabilizer 116 described above, the crossbar 400 can be integral with the toothbrush 100 or can be removably or permanently attached.

To provide lateral stability, the crossbar legs 402 and 404, in one embodiment of the present invention, have a highly-frictional material, such as rubber, on a bottom surface (not shown in this view), which makes frictional contact with a horizontal surface 409 upon which the toothbrush 100 and crossbar 400 are placed. The friction-causing material prevents the crossbar 400 from sliding laterally (indicated by arrows around the crossbar 400) across the surface 409.

In another embodiment, also shown in FIG. 4, the toothbrush 100 has a stabilizer fin 408 on the distal end 110. The stabilizer fin 409 can be provided separately or used in conjunction with the crossbar 400, but in any case, provides stability to the toothbrush 100 and allows toothpaste to be applied to the bristles 406 without the need to hold the brush 100 and without the brush 100 rolling over. As with the crossbar 400, an underside of the fin 408 can be coated with a friction-causing material that prevents the fin 408 from sliding laterally (indicated by arrows around the fin 408) across the surface 408.

It is noted that the shapes of the crossbar 400 and the fin 408 shown in FIG. 4 are merely exemplary and that the crossbar 400 and the fin 408 do not have to have these specific shapes, but can be many others. As with the suction device 116, shown in FIGS. 1-3, the crossbar 400 and the fin 408 are present for the purpose of providing both lateral and rollover stability to the toothbrush 100. In preferred embodiments, the suction device 116, crossbar 400, and/or fin 408 are of a size and in a location that causes minimal interference with a user's hand when brushing. Generally speaking, the crossbar 400 and the fin 408 extend away from a longitudinal axis 410 of the toothbrush 100 in two directions perpendicular to the axis 410, thereby providing rollover stability to the toothbrush when placed on a surface 409. Furthermore, the suction device 116, crossbar 400, and/or fin 408 can all be removably attached to the toothbrush 100 and/or can be permanently or semi-permanently affixed to a surface.

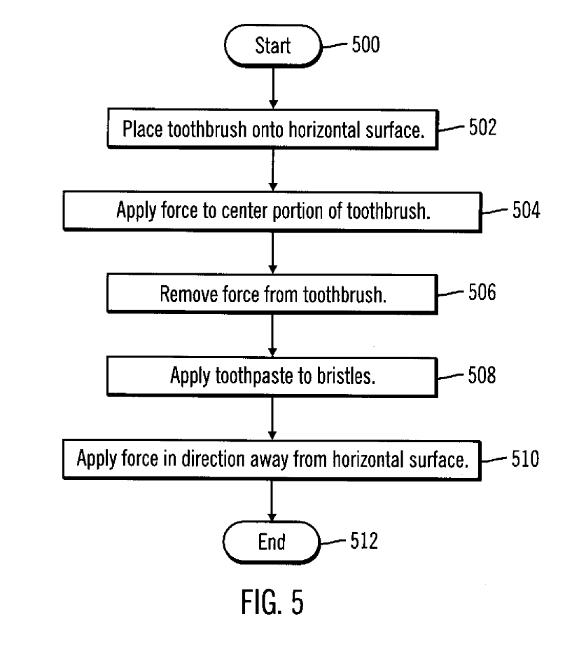

FIG. 5 shows a flow diagram of a toothbrush stabilization process in accordance with a first embodiment of the present invention. The process begins at step 500 and moves directly to step 502 where a suction device of a toothbrush is placed onto a substantially horizontal surface. In step 504, force is applied to a center portion of the toothbrush adjacent the suction device. The force is in a direction toward the horizontal surface and is sufficient to deform the suction device so that air is forced out of a void defined by the suction device and the surface. In step 506, the force is removed from the toothbrush. In step 508, a substance, such as toothpaste, is applied to bristles on the toothbrush. In step 510, enough force is applied to the toothbrush in a direction away from the horizontal surface to overcome the suction applied to the surface by the suction device. The toothbrush is used in step 512 with one hand. The process ends at step 514.

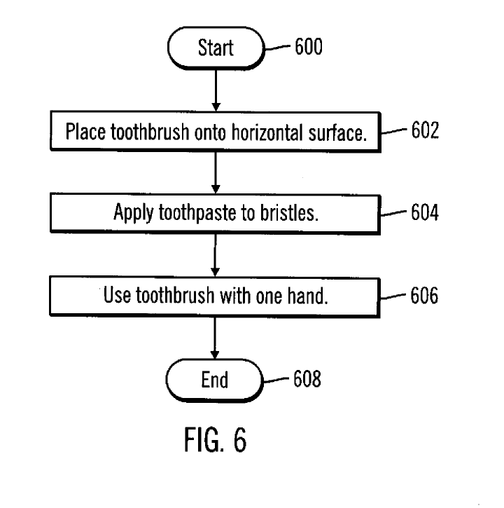

FIG. 6 shows a flow diagram of a toothbrush stabilization process in accordance with a second embodiment of the present invention. The process begins at step 600 and moves directly to step 602 where a crossbar 400 or fin 408, or both, of a toothbrush 100 is placed onto a substantially horizontal surface. In step 604, a substance, such as toothpaste, is applied to bristles on the toothbrush, exerting a lateral (in reference to the surface on which the toothbrush is resting) force on the bristles of the brush. In step 606, the toothbrush is used with one hand. The process ends at step 608.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

What is claimed is:

1. A toothbrush comprising:
a handle having:
a first side;
a second side opposing the first side;
a distal end; and
a proximal end opposing the distal end, the proximal end having bristles on the first side; and
a stabilizer located on the second side of the handle substantially centered between the proximal end and the distal end.

2. The toothbrush according to claim 1, wherein the stabilizer a suction device.

3. The toothbrush according to claim 2, wherein the suction device is a suction cup.

4. The toothbrush according to claim 1, wherein the stabilizer is a crossbar.

5. The toothbrush according to claim 4, further comprising:
a friction-causing material on a bottom surface of the crossbar.

6. The toothbrush according to claim 1, wherein the stabilizer is integrated into the handle.

7. The toothbrush according to claim 1, wherein the stabilizer is removably attached to the handle.

8. The toothbrush according to claim 1, wherein substantially centered is defined as being within about 35% of a total length of the toothbrush from a point halfway between an extent of the distal end and an extent of the proximal end.

9. The toothbrush according to claim 1, wherein substantially centered is defined as being spaced away from an extent of the distal end and an extent of the proximal end by a distance of at least 15% of a total length of the toothbrush.

10. A toothbrush comprising:
a first side;
a second side opposing the first side;
a distal end;
a proximal end opposing the distal end, the proximal end having bristles on the first side; and
a stabilizer located on the second side of the distal end, the stabilizer extending away from a longitudinal axis of the toothbrush in two directions and providing rollover stability to the toothbrush when placed on a surface.

11. The toothbrush according to claim 10, wherein the stabilizer is a fin.

12. The toothbrush according to claim 10, further comprising:
a friction-causing material on a bottom surface of the stabilizer.

13. The toothbrush according to claim 10, wherein the stabilizer is an integral part of the toothbrush.

14. The toothbrush according to claim 10, wherein the stabilizer is removably attached to the toothbrush.

15. A method for applying a substance to bristles on a toothbrush, the method comprising:
placing a toothbrush onto a substantially horizontal surface;
applying force to a center portion of the toothbrush in a direction toward the horizontal surface sufficient to deform a suction device attached to the toothbrush;
removing the force; and
applying a substance to bristles on the toothbrush.

16. The method according to claim 15, which further comprises substantially centering the suction device between a proximal end and a distal end of the toothbrush.

17. The method according to claim 15, wherein the center portion is within about 35% of a point halfway between a longitudinal extent of the toothbrush.

18. The method according to claim 15, wherein the suction device is integral with the toothbrush.

19. The method according to claim 15, wherein the suction device is removably attached to the toothbrush.
